(19) United States
(12) Patent Application Publication
(10) Pub. No.: US 2022/0289964 A1
(43) Pub. Date: Sep. 15, 2022

(54) LOW-TOXICITY FLAME-RETARDANT POLYOLEFIN-BASED INSULATING RESIN COMPOSITION, INSULATED ELECTRIC CABLE, AND METHOD OF MANUFACTURING INSULATED ELECTRIC CABLE

(71) Applicant: TSC CO., LTD., Gyeonggi-do (KR)

(72) Inventors: Chan Yong SEONG, Gyeonggi-do (KR); Dong Hun KIM, Incheon (KR); Kyoung Jin KIM, Gyeonggi-do (KR); Hwan Chul BAE, Gyeonggi-do (KR); Yu Jin NAM, Incheon (KR); Dong Wook KIM, Gyeonggi-do (KR); Jo Eun LEE, Chungcheongnam-do (KR); Dong Ki CHO, Chungcheongnam-do (KR)

(21) Appl. No.: 17/805,132

(22) Filed: Jun. 2, 2022

Related U.S. Application Data
(63) Continuation of application No. PCT/KR2020/018979, filed on Dec. 23, 2020.

(30) Foreign Application Priority Data
Dec. 24, 2019 (KR) 10-2019-0174380

(51) Int. Cl. C08L 51/00; C09K 21/02; C09K 21/06; C08L 23/08; C08J 3/24; C08J 3/20; H01B 3/44; H01B 7/295; H01B 13/14

(52) U.S. Cl. CPC C08L 51/003; C09K 21/02; C09K 21/06; C08L 23/0815; C08L 23/0869; C08J 3/24; C08J 3/203; H01B 3/441; H01B 7/295; H01B 13/14; C08L 2201/02; C08L 2205/025; C08L 2205/035; C08L 2312/00; C08L 2203/202; C08J 2351/08; C08J 2451/08; C08J 2323/08; C08J 2423/08

(57) ABSTRACT

The present disclosure relates a low-toxicity flame-retardant polyolefin-based insulating resin composition, a low-toxicity flame-retardant polyolefin-based insulated electric cable, and a method of manufacturing the insulated electric cable. The low-toxicity flame-retardant polyolefin-based insulating resin composition includes 100 parts by weight of a base resin and 120 to 140 parts by weight of a flame retardant. The base resin includes 20% to 40% by weight of polyethylene ethyl acrylate, 20% to 40% by weight of polyolefin elastomer, and 30% to 40% by weight of a linear low-density polyethylene resin grafted with maleic anhydride. The flame retardant is magnesium hydroxide that is surface-treated with a silane coupling agent. With the use of the composition, the low-toxicity flame-retardant insulated wire exhibiting good electrical insulation and anti-scratch characteristics and having good appearance can be obtained.

### CROSS REFERENCE TO RELATED APPLICATION

This is a continuation of International Application No. PCT/KR2020/018979 filed on Dec. 23, 2020, which claims priority from Korean Patent Application No. 10-2019-0174380 filed on Dec. 24, 2019. The contents of these applications are incorporated herein by reference in their entireties.

### TECHNICAL FIELD

The present disclosure relates to a low-toxicity flame-retardant polyolefin-based insulating resin composition and to wires and cables using the same. More particularly, the present disclosure relates to a low-toxicity flame-retardant cross-linked polyolefin-based insulating resin composition using a halogen-free flame retardant, an insulated electric cable using the same, and a manufacturing method thereof.

### BACKGROUND

An insulated electric cable refers to a wire prepared by coating a conductor with an insulation material such as lead-free heat-resistant polyvinyl chloride (PVC) or low-toxicity polyolefin.

So-called low-toxicity flame-retardant cross-linked polyolefin insulated electric cable is an insulated electric cable that meets the quality standards of KS C3341. These wires are insulated electric cables used as wires in general electrical works or electrical devices of 450V to 750V. It is an insulated electric cable with low toxicity and low flammability, which can be used for wiring inside buildings and confined spaces that require minimization of toxicity and flammability.

Halogen-based synthetic resins such as polyvinyl chloride (PVC), which were used in the past, have been avoided due to the demand for low-toxicity flame-retardant electric cables. In addition, flame retardants containing halogen elements, for example, polybrominated biphenyl, polybrominated diphenyl ether, etc. have also been avoided.

Accordingly, polyethylene and ethylene-vinyl acetate (EVA) have been mainly used as base resins, and metal hydroxides such as magnesium hydroxide or aluminum hydroxide have been used as flame retardants.

However, when metal hydroxide, which is a halogen-free flame retardant, is used, it is inevitable to use a large amount of metal hydroxide in order to meet the desired flame retardancy. However, the use of a large amount of metal hydroxide acts as a factor to lower the electrical insulation of the electric cable. In addition, scratches easily remain on the surface of the electric cable during extrusion, causing a problem that lowers the commercial value of the electric cable. In addition, when the electric cable is extruded, the production speed is slowed, which may cause a problem of lowering the production productivity of the electric cable.

In relation to this, Korea Patent Application Publication No. 10-2017-0068091 discloses an insulating composition comprising, as a base resin, 20 to 40 parts by weight of high-density polyethylene, 20 to 40 parts by weight of polyolefin elastomer, 10 to 30 parts by weight of ethylene vinyl acetate, and 15 to 35 parts by weight of linear low-density polyethylene grafted with maleic anhydride. This insulating composition has abrasion resistance and high temperature water resistance satisfying LV-112, which is a European automobile integrated standard, and is excellent in flexibility, flame retardancy, and cold resistance. The document discloses that the flame retardant may include a metal hydroxide such as aluminum hydroxide or magnesium hydroxide, and the metal hydroxide may be coated with vinyl silane and the like so that the surface thereof is modified to be hydrophobic.

As another related art, Korean Patent No. 10-1256800 discloses a low-toxicity flame-retardant cross-linked polyolefin coated insulator composition for insulated cables, the composition comprising, as a base resin, 20 to 40 parts by weight of ethylene vinyl acetate, 30 to 40 parts by weight of ethylene methyl acrylate, 20 to 30 parts by weight of linear low-density polyethylene, and 10 to 20 parts by weight of maleic anhydride grafted ethylene vinyl acetate, the composition further comprising 150 to 180 parts by weight of magnesium hydroxide coated with a silane compound, 3 to 5 parts by weight of primary antioxidant, 1 to 2 parts by weight of secondary antioxidant, 0.5 to 2 parts by weight of primary weathering resistance agent, 0.5 to 2 parts by weight of secondary weathering resistance parts by weight, 2 to 5 parts by weight of an extrusion enhancer, 2 to 5 parts by weight of a cross-linking aid, and 5 to 8 parts by weight of the cross-linking agent. The document also discloses an electric cable manufactured from the composition. The composition enables the manufacture of electric cables by continuous extrusion cross-linking and satisfies all the properties required for HFIX (halogen-free flame-retardant cross-linked polyolefin insulation wire (HFIX; KS C 3341 standard).

### SUMMARY

An objective of the present disclosure is to provide an insulating resin composition enabling an extrudate capable of improving electrical insulation, implementing low toxicity and flame retardancy, and having excellent scratch resistance and good appearance, while improving the production rate during extrusion.

Another objective of the present disclosure is to provide a method of manufacturing a low-toxicity flame-retardant cross-linked polyolefin-based insulated electric cable that has good appearance when extruded and can improve the production rate during extrusion.

A further objective of the present disclosure is to provide a low-toxicity flame-retardant cross-linked polyolefin-based insulated electric cable having excellent electrical insulation, excellent scratch resistance, good appearance, low toxicity, and flame retardancy.

One embodiment of the present disclosure provides a low-toxicity flame-retardant polyolefin-based insulating resin composition including: 100 parts by weight of base resin including 20% to 40% by weight of polyethylene ethyl acrylate, 20% to 40% by weight of polyolefin elastomer, and 30% to 40% by weight of a linear low-density polyethylene resin grafted with maleic anhydride; and 120 to 140 parts by weight of magnesium hydroxide surface-treated with a silane coupling agent as a flame retardant.

A specific embodiment of the present disclosure provides a low-toxicity flame-retardant polyolefin-based insulating resin composition including: a primary compound composition including 100 parts by weight of a base resin and a flame retardant, the base resin including 20% to 40% by weight of polyethylene ethyl acrylate, 20% to 40% by weight of polyolefin elastomer, and 30% to 40% by weight of a linear low-density polyethylene resin grafted with maleic anhydride, the flame retardant including 120 to 140 parts by weight of magnesium hydroxide that is surface-treated with a silane coupling agent; and a cross-linking agent.

In the insulating resin composition according to one embodiment of the present disclosure, the polyolefin elastomer may include an ethylene-octene-based copolymer, an ethylene-butene-based copolymer, or a mixture thereof.

In the insulating resin composition according to one embodiment of the present disclosure, preferably, the cross-linking agent may include a mixture of vinyltrimethoxysilane (VTMOS) and dicumyl peroxide in consideration of cross-linking properties and extruded appearance.

In the insulating resin composition according to a more preferred embodiment, the cross-linking agent may a mixture of 1 to 2 parts by weight of vinyltrimethoxysilane (VTMOS) and 0.1 to 0.12 parts by weight of dicumyl peroxide, with respect to 100 parts by weight of the primary compound composition.

The present disclosure provides a low-toxicity flame-retardant polyolefin-based insulated electric cable including a cross-linked product of a primary compound including: 100 parts by weight of a base resin including 20% to 40% by weight of polyethylene ethyl acrylate, 20% to 40% by weight of polyolefin elastomer, and 30% to 40% by weight of a linear low-density polyethylene resin grafted with maleic anhydride; and 120 to 140 parts by weight of magnesium hydroxide that is surface-treated with a silane coupling agent, as a flame retardant.

In the insulated electric cable according to one embodiment of the present disclosure, the polyolefin elastomer may include an ethylene-octene-based copolymer, an ethylene-butene-based copolymer, or a mixture thereof.

In the insulated electric cable according to one embodiment of the present disclosure, the cross-linked product may be obtained by using a mixture of vinyltrimethoxysilane (VTMOS) and dicumyl peroxide as the cross-linking agent, and more preferably, the cross-linked product may be obtained by using a mixture of 1 to 2 parts by weight of vinyltrimethoxysilane (VTMOS) and 0.1 to 0.12 parts by weight of dicumyl peroxide, with respect to 100 parts by weight of the first compound composition, as the cross-linking agent.

Another embodiment of the present invention provides a method of manufacturing a low-toxicity flame-retardant polyolefin-based insulated electric cable. The method includes a process S1 of preparing a primary compound by compounding a composition including: 100 parts by weight of a base resin including 20% to 40% by weight of polyethylene ethyl acrylate, 20% to 40% by weight of polyolefin elastomer, and 30% to 40% by weight of a linear low-density polyethylene resin grafted with maleic anhydride; and 120 to 140 parts by weight of magnesium hydroxide surface-treated with a silane coupling agent, as a flame retardant. The method also includes a process S2 of producing a cross-linked product by reactive extrusion of the primary compound.

In the method according to one embodiment of the present disclosure, the polyolefin elastomer may include an ethylene-octene-based copolymer, an ethylene-butene-based copolymer, or a mixture thereof.

In the method according to one embodiment of the present disclosure, the reactive extrusion may be performed using a mixture of vinyltrimethoxysilane (VTMOS) and dicumyl peroxide as a cross-linking agent. In the method according to a more preferred embodiment, the reactive extrusion may be performed by using, as the cross-linking agent, a mixture of 1 to 2 parts by weight of vinyltrimethoxysilane (VTMOS) and 0.1 to 0.12 parts by weight of dicumyl peroxide, with respect to 100 parts by weight of the primary compound composition.

The present disclosure can provide an insulating resin composition that enables an extrudate having improved electrical insulation property, low-toxicity flame retardancy, excellent scratch resistance, and good appearance quality and which improves a production rate during extrusion. The present disclosure can also provide a method of manufacturing a low-toxicity flame-retardant cross-linked polyolefin-based insulated electric cable that has excellent external appearance and can improve production speed during extrusion through cross-linking reactive extrusion of the same insulating resin composition. Thus, the present disclosure can provide a low-toxicity flame-retardant cross-linked polyolefin-based insulated electric cable with excellent scratch resistance, good appearance, low toxicity, and flame retardancy.

### BRIEF DESCRIPTION OF DRAWINGS

FIG. 1 illustrate an example of a flowchart of manufacturing a low-toxicity flame-retardant polyolefin-based insulated electric cable, according to one embodiment of the present disclosure.

### DETAIL DESCRIPTION

Hereinafter, the present disclosure will be described in detail.

The present disclosure provides a low-toxicity flame-retardant polyolefin-based insulating resin composition including: 100 parts by weight of a base resin including 20% to 40% by weight of polyethylene ethyl acrylate, 20% to 40% by weight of polyolefin elastomer, and 30% to 40% by weight of a linear low-density polyethylene resin grafted with maleic anhydride; and 120 to 140 parts by weight of magnesium hydroxide surface-treated with a silane coupling agent as a flame retardant.

The standard of KS C 3341 related to low-toxicity flame-retardant cross-linked polyolefin insulated electric cable requires the following performance:

Tensile strength—9 N/mm² (92 Kgf/cm²) or more, Elongation (%)—125% or more,

Tensile strength change rate after thermal aging (135° C.×168 hr)—within ±40%,

Elongation change rate after thermal aging (135° C.×168 hr)—within ±40%,

HOT/SET—175 or less/15 or less, and

High-temperature electrical insulation resistance—3.67 mΩ·km or more

The low-toxicity flame-retardant polyolefin-based insulating resin composition of the present disclosure does not contain ethylene vinyl acetate (EVA), low-density polyethylene (LDPE), low-density linear polyethylene (LLDPE) or high-density polyethylene (HDPE) but contains polyethylene ethyl acrylate (EEA), polyolefin elastomer (POE), and a linear low-density polyethylene resin grafted with maleic anhydride, as a base resin.

When a polyolefin elastomer is included as a base resin, excellent insulation satisfying high-temperature electrical insulation prescribed in KS C 3341 can be exhibited.

The polyolefin elastomer may include an ethylene-octene-based copolymer, an ethylene-butene-based copolymer, or a mixture thereof, but may not be limited thereto. Preferably, the polyolefin elastomer may be an ethylene-octene-based copolymer.

Preferably, the content of the polyolefin elastomer is 20% to 40% by weight with respect to 100 parts by weight of the base resin from the viewpoint of improving electrical insulation.

In addition, polyethylene ethyl acrylate contained as the base resin in the insulating resin composition of the present disclosure is a copolymer of ethylene and ethyl acrylate. This base resin has a higher thermal decomposition initiation temperature than that of ethylene vinyl acetate, has thermal stability similar to that of low-density polyethylene, and does not corrode a molding machine even when the base resin is thermally decomposed. Due to these characteristics, when polyethylene ethyl acrylate is included as a base resin, sufficient flame retardancy can be exhibited. In particular, sufficient flame retardancy can be obtained in a vertical arrangement test (Cable Vertical Ignition), which is a flame retardancy test of an electric cable.

In addition, since polyethylene ethyl acrylate is included as the base resin, there is an advantage of reducing the amount of smoke in case of fire.

When a fire occurs, the fire causes not only property damage but also great personal injury. It has been reported that smoke and toxic gases generated by combustion of combustibles in a fire event are the main causes of casualties. According to the National Fire Data System, most of the casualties in fires result from smoke and toxic gases.

When a fire event occurs and a large amount of smoke is generated, light transmission is lowered, causing great obstacles to evacuation and fire extinguishing activities in a fire event, resulting in great loss of lives. In addition, while the flame limitedly occurs within a specific area where the fire has occurred, the smoke spreads not only to the adjacent area but also to a far-off area. Therefore, exposure to smoke is more extensive rather than exposure to heat, resulting in more casualties.

In the present disclosure, when polyethylene ethyl acrylate is included as the base resin, it may be advantageous in that the amount of smoke can be significantly reduced compared to the case of using a conventional base resin such as ethylene vinyl acetate.

In the present disclosure, preferably, the content of ethylene acrylate (EA) as a comonomer in the polyethylene ethyl acrylate is 10% to 15% by weight of the total resin.

In terms of flame retardancy, the content of polyethylene ethyl acrylate is preferably 20% to 40% by weight with respect 100 parts by weight of the base resin.

On the other hand, the insulating resin composition of the present disclosure includes a linear low-density polyethylene resin grafted with maleic anhydride as the base resin. This has a strong polar group compared to other resins and has a remarkably high affinity with inorganic materials, thereby improving the bonding strength with the resin. Thus, physical properties such as tensile strength and elongation are improved.

In the present disclosure, in the maleic anhydride-grafted linear low-density polyethylene resin, the maleic anhydride grafting ratio may be preferably 0.3% to 0.6% by weight. The content of the maleic anhydride-grafted linear low-density polyethylene resin in the total base resin is preferably 30% to 40% by weight with respect to 100 parts by weight of the total base resin in terms of physical properties.

On the other hand, the insulating resin composition of the present disclosure includes a halogen-free flame retardant, and the flame retardant may preferably be magnesium hydroxide surface-treated with a silane coupling agent.

In terms of scratch-resistance, when the surface of the wire is easily scratched during distribution or in installation sites, the scratches negatively affect not only marketability but also durability, thereby deteriorating various physical properties including an insulating property. For this reason, scratch resistance is one of the particular crucial factors.

When magnesium hydroxide surface-treated with a silane coupling agent is used as a flame retardant, scratch resistance is remarkably improved, and durability can be improved.

In addition, when magnesium hydroxide surface-treated with a silane coupling agent is used as a flame retardant, scratch resistance can be improved, and the extrusion speed can also be improved. In a wire extrusion process, the extrusion speed is directly connected to productivity.

A wire extruder commonly used by wire companies is a 100-mm extruder, and the most common screw for the extruder has a length/diameter ratio of 20/1 to 26/1 and a compression ratio of 1.5 to 2.5. The wire of a commonly used size is 1.5 SQ to 6 SQ, and a generalized evaluation for good productivity is that the length of the wire manufactured per minute must be 150 m or more. A preferable wire extrusion speed is 150 m/min or more.

In the present disclosure, when magnesium hydroxide surface-treated with a silane coupling agent is used as a flame retardant in the present disclosure, even though the amount used is high enough to exhibit sufficient flame retardancy, there is an advantage in that the above-described extrusion speed can be sufficiently exhibited. This is because in magnesium hydroxide surface-treated with a silane coupling agent, slip resistance is given to the surface of magnesium hydroxide due to the silane coupling agent used for the surface treatment, so that even in a resin containing a large amount of it, scratch resistance can be improved on the product surface. Also, it is possible to increase the line speed during extrusion.

In the insulating resin composition of the present disclosure, in the case of using magnesium hydroxide that is surface-treated with a silane coupling agent, it is preferable that the content of the magnesium hydroxide is 120 to 140 parts by weight per 100 parts by weight of the base resin in terms of flame retardancy, scratch resistance, and extrudability.

Of course, as a flame retardant, in addition to the magnesium hydroxide that is surface-treated with a silane coupling agent, a halogen-free flame retardant such as magnesium hydroxide or aluminum hydroxide whose surface is not treated may be further included.

Of course, the insulating resin composition of the present disclosure may further include additives such as lubricants and antioxidants.

In order for such compositions to be prepared into a cross-linked product, the compositions may be processed with a kneader or the like to be provided as a primary compound composition. An insulating resin as a final product can be obtained by blending a cross-linking agent with the composition and extruding the mixture.

The resin composition of the present disclosure includes a cross-linking agent, which is added to improve the strength or heat resistance through cross-linking of the base resin.

Cross-linking of polyolefins may be silane cross-linking or peroxide cross-linking. Depending on the cross-linking conditions, the speed of the cross-linking may vary, and the thermal properties of the cross-linked product may change.

In consideration of this point, in the insulating resin composition of the present disclosure, a mixture of vinyltrimethoxysilane and dicumyl peroxide may be included as the cross-linking agent to use both the silane cross-linking and the peroxide cross-linking.

In particular, in the hot set test of IEC 60502 to determine the cross-linking properties, to satisfy cross-linking properties of hot elongation (%)/permanent set (%) of 175/115 or less, the cross-linking agent preferably includes a mixture of 1 to 2 parts by weight of vinyl trimethoxy silane (VTMOS) and 0.1 to 0.12 parts by weight of dicumyl peroxide per 100 parts by weight of the primary compound composition.

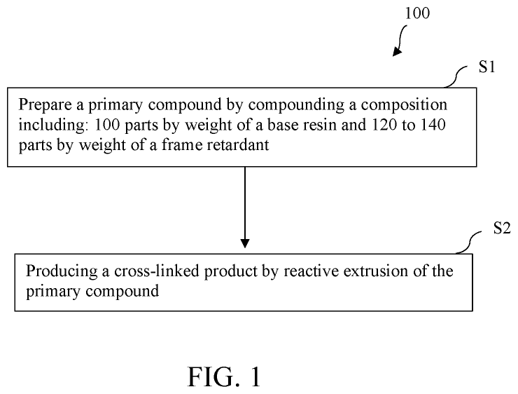

FIG. 1 illustrate an example of a flowchart of manufacturing a low-toxicity flame-retardant polyolefin-based insulated electric cable, according to one embodiment of the present disclosure.

The method 100 of manufacturing an insulated electric cable from such an insulating resin composition includes: preparing S1 a primary compound composition comprising 100 parts by weight of a base resin and 120 to 140 parts by weight of a flame retardant, the base rein comprising 20% to 40% by weight of polyethylene ethyl acrylate, 20% to 40% by weight of polyolefin elastomer, and 30% to 40% by weight of a linear low-density polyethylene resin grafted with maleic anhydride, the flame retardant comprising magnesium hydroxide that is surface-treated with a silane coupling agent; and producing S2 a cross-linked product by performing reactive extrusion with the primary compound.

Here, in the reaction extrusion, the cross-linking reaction of the primary compound obtained by compounding the resin composition that does not include a cross-linking agent is performed such that a chemical reaction simultaneously and the extrusion are simultaneously performed. Considering this reaction extrusion, a mixture of vinyltrimethoxysilane (VTMOS) and dicumyl peroxide may be used as a cross-linking agent. Preferably, a mixture of 1 to 2 parts by weight of vinyl trimethoxy silane (VTMOS) and 0.1 to 0.12 parts by weight of dicumyl peroxide per 100 parts by weight of the primary compound may be used as a cross-linking agent.

As a specific example, after kneading the components for preparation of a primary compound with a kneader until the temperature reaches 120° C. to 140° C., melting and kneading are performed at a temperature in the range of 120° C. to 150° C. with the use of a single screw extruder, followed by cooling to prepare the primary compound. This primary extrudate is strand-cut to prepare pellets.

Then, a mixture of vinyl trimethoxy silane and dicumyl peroxide, which is a cross-linking agent, added to and dry-blended with the pellets in a temperature range of 50° C. to 90° C. for about 5 minutes, and the resultant is extruded into a secondary extrudate with the use of an extruder.

In this case, if the cross-linking agent is added at the time of adding the base resin and the flame retardant, the process can be simplified, but there are various problems such that the extrusion appearance is not good, and the cross-linking stability and tensile strength are deteriorated. Therefore, it is preferable that the cross-linked product is obtained in a manner that the base resin and the flame retardant are first mixed to prepare the primary compound first, and then the cross-linking agent is added to the primary compound.

Through this method, the present disclosure can provide a low-toxicity flame-retardant polyolefin-based insulated electric cable including a cross-linked product of a primary compound including: 100 parts by weight of a base resin including 20% to 40% by weight of polyethylene ethyl acrylate, 20% to 40% by weight of polyolefin elastomer, and 30% to 40% by weight of a linear low-density polyethylene resin grafted with maleic anhydride; and 120 to 140 parts by weight of magnesium hydroxide that is surface-treated with a silane coupling agent, as a flame retardant.

The obtained insulated electric cable can realize low-toxicity flame retardancy, exhibit excellent properties at room temperature, and satisfy excellent high-temperature insulation resistance, as well as has excellent scratch resistance and excellent appearance quality. Since it is possible to mass-produce such electric cable with superior quality, the present disclosure is industrially useful.

### MODES FOR DISCLOSURE

Hereinafter, preferred examples are presented to help the understanding of the present disclosure, and the following examples are only illustrative of the present disclosure and the scope of the present disclosure is not limited by these examples.

### Examples 1 to 4

After kneading the components as shown in Table 1 in a kneader until reaching 120° C. to 140° C., melting and kneading are performed at 120° C. to 150° C. with the use of a single screw extruder, followed by cooling to prepare a primary compound. This primary extrudate was strand-cut to prepare pellets.

Then, vinyl trimethoxy silane and dicumyl peroxide were dry blended with the pellets in a temperature range of 50° C. to 90° C. for about 5 minutes, and the mixture was extruded into a secondary extrudate with the use of an extruder.

TABLE 1

| processing | | | | | | |
|---|---|---|---|---|---|---|
| sequence | | name of | | | | |
| and | | raw | example | | | |
| equipment | raw material | material | 1 | 2 | 3 | 4 |
| primary | base resin | EEA | 30 | 20 | 40 | 30 |
| compound | (100 parts by | POE | 30 | 40 | 20 | 40 |
| (kneading) | weight) | Graft | 40 | 40 | 40 | 30 |
| | | Resin | | | | |
| | flame retardant | Si-MDH | 130 | 130 | 130 | 130 |
| | (part by weight) | | | | | |
| | other additives | PE wax | 4 | 4 | 4 | 4 |
| | (part by weight) | Antioxidant | 3 | 3 | 3 | 3 |
| secondary | primary compound | | 100 | 100 | 100 | 100 |
| compound | cross-linking | VTMOS | 1.5 | 1.5 | 1.5 | 1.5 |
| processing | agent | DCP | 0.12 | 0.12 | 0.12 | 0.12 |
| with | (part by weight) | | | | | |
| uniaxial | | | | | | |
| extruder | | | | | | |

EEA Co., Ltd.: polyethylene ethyl acrylate resin with EA content of 15%, MI (190° C., 2.16 Kg) (g/10 min) 0.5 to 1.0, Japan Polyethylene Corporation, A1150
POE: DSC melting point 58° C.-98° C., MI (190° C., 2.16 Kg) (g/10 min) 1-2 polyethylene elastomer (specifically, ethylene-1-octene copolymer), LG company, POE LC-170
Graft Resin: resin with 0.5% MALEIC ACID grafted on LLDPE BASE, MI (190° C.) 0.7~1.5, Lotte Chemical company, EM-510M
Si-MDH: magnesium hydroxide flame retardant which is surface-treated with silane coupling agent, the average particle size 1.0 μm-1.1 μm, Konoshima S-6
PE Wax: Lion Chemtech, LC-102N
Antioxidant: phenol-based antioxidant, Songwon Industries, AO 1076
VTMOS: Vinyltrimethoxysilane, WACKER, OFS-6300
DCP: dicumyl peroxide, a product of AKZO NOBEL
The secondary extrudate obtained as described above was evaluated for tensile strength and elongation, high temperature insulation resistance, thermal aging characteristics, cross-linking characteristics, and flame retardancy in a manner described below, and the results are shown in Table 2.

(1) Tensile strength: tensile strength was measured using IEC 60502.

(2) High temperature insulation resistance: insulation resistance was measured using IEC 60502.

(3) Hydrogen chloride gas generation: refers to the standard value of hydrogen chloride gas generation 0.5 or less according to the test method of IEC 60754-1.

(4) Cross-linking properties (Hot/Set (%)): measured using IEC 60502.

(5) Flame retardancy: tested according to UL94 and satisfies VO grade or higher

(6) Scratch resistance: the scratch resistance was compared with the results of the abrasion resistance test. The abrasion resistance test was performed through a needle scrape test in which a 310-g weight was placed on a 0.45 SQ needle placed on an extruded specimen with a thickness of 1 mm, a width of 2 mm, and a length of 100 mm, and the needle scratches the specimen through reciprocation motion. It is required that no hole is formed in the specimen even after reciprocating the needle more than 100 times.

When a hole is formed in the specimen before reaching 100 times of reciprocating motion, it is considered that the abrasion is not good.

As a result of the test, when the number of reciprocating trips was more than 100 times, there was no problem with the scratch property in the electric wire. Accordingly, the scratch resistance was determined to be good or bad by setting the 100 times of the abrasion resistance test result as a reference value.

TABLE 2

| | measure- | | | | | required |
|---|---|---|---|---|---|---|
| | ment | Example | | | | perfor- |
| | item | 1 | 2 | 3 | 4 | mance |
| room | tensile | 13 | 13.2 | 12.1 | 122.8 | 9 or more |
| temper- | strength | | | | | |
| ature | (N/mm²) | | | | | |
| | Elongation | 250 | 265 | 250 | 195 | 125 or |
| | (%) | | | | | more |
| high | insulation | 100 | 110 | 8 | 202 | 3.67 or |
| temper- | resistance | | | | | more |
| ature | (MΩ*km) | | | | | |
| (90° C.) | | | | | | |
| thermal | tensile | 20 | 18 | 12 | 15 | ±40 or |
| aging | strength | | | | | less |
| (135° C. × | change (%) | | | | | |
| 168 hrs) | elongation | −15 | −19 | −15 | −15 | ±40 or |
| | change (%) | | | | | less |
| | amount of | 0.03 | 0.08 | 0.03 | 0.04 | 0.5 or |
| | hydrogen | | | | | less |
| | chloride gas | | | | | |
| | generated | | | | | |
| | (%) | | | | | |
| cross- | HOT/SET | 100/5 | 100/5 | 75/0 | 100/15 | 175/15 or |
| linking | (%) | | | | | less |
| character | | | | | | |
| -istics | | | | | | |
| flame | Cable | Pass | Pass | Pass | Pass | natural |
| retardancy | Vertical | | | | | extin- |
| | Ignition | | | | | guishing |
| | scratch | 152 | 148 | 142 | 125 | 100 or |
| | resistance | | | | | more |
| | (count of | | | | | |
| | round trips) | | | | | |
| cable | speed of | 150 | 150 | 150 | 150 | 150 or |
| workability | cable | or | or | or | or | more |
| | working | more | more | more | more | |
| | (M/min) | | | | | |

| | | | | |
|---|---|---|---|---|
| Appropriate | appro- | appro- | appro- | appro- |
| /inappropriate | priate | priate | priate | priate |

From the results of Table 2, it was confirmed that when the polyethylene ethyl acrylate resin was included in an amount of 20% to 40% by weight of the base resin, the insulation resistance was increased. That is, such a content range was preferable in terms of improvement in electrical insulation. In addition, a material including 20% to 40% by weight of a polyethylene ethyl acrylate resin and 30% to 40% by weight of a linear low-density polyethylene resin grafted with maleic anhydride showed satisfactory results in terms of flame retardancy.

### Comparative Examples 1 to 4

An extrudate was prepared in the same manner as in Example 1, except that the compositions shown in Table 3 were used. Specific use examples of the remaining raw materials except for EVA are the same as those used in the above examples.

TABLE 3

| processing | | | | | | | |
|---|---|---|---|---|---|---|---|
| sequence | | name of | | | | | |
| and | raw | raw | comparative example | | | | |
| equipment | material | material | 1 | 2 | 3 | 4 | 5 |
| primary | base resin | EEA | 10 | 50 | 30 | 30 | 30 |
| compound | (100 parts | POE | 50 | 10 | 50 | — | 30 |
| (kneading) | by weight) | EVA | — | — | — | 30 | 40 |
| | | Graft | 40 | 40 | 20 | 40 | — |
| | | Resin | | | | | |
| | flame | Si-MDH | 130 | 130 | 130 | 130 | 130 |
| | retardant | | | | | | |
| | (part by | | | | | | |
| | weight) | | | | | | |
| | other | PE wax | 4 | 4 | 4 | 4 | 4 |
| | additives | antiox- | 3 | 3 | 3 | 3 | 3 |
| | (part by | idant | | | | | |
| | weight) | | | | | | |
| secondary | primary compound | | 100 | 100 | 100 | 100 | 100 |
| compound | cross- | VTMOS | 1.5 | 1.5 | 1.5 | 1.5 | 1.5 |
| processing | linking | DCP | 0.12 | 0.12 | 0.12 | 0.12 | 0.12 |
| with | agent | | | | | | |
| uniaxial | (part by | | | | | | |
| extruder | weight) | | | | | | |

EVA Co., Ltd.: content of vinyl acetate (VA) was 22% by weight, M.I (190° C., 2.16 Kg) (g/10 min) 2 − 3, ethylene vinyl acetate, Hanwha Total Petrochemical, E220F

The extrudate obtained as described above was evaluated by the evaluation method described in Examples 1 to 4, and the results are shown in Table 4 below.

TABLE 4

| | measurement | comparative example | | | | | required |
|---|---|---|---|---|---|---|---|
| | item | 1 | 2 | 3 | 4 | 5 | performance |
| room | tensile | 13.4 | 10.3 | 8.7 | 10 | 7~8 | 9 or more |
| temperature | strength | | | | | | |
| | (N/mm²) | | | | | | |
| | Elongation | 273 | 210 | 160 | 200 | 180 | 125 or more |
| | (%) | | | | | | |
| high | insulation | 110 | 2.5 | 313 | 0.5~3 | 10 | 3.67 or more |
| temperature | resistance | | | | | | |
| (90° C.) | (MΩ*km) | | | | | | |
| thermal | tensile | 18 | 10 | 20 | 25 | 22 | ±40 or less |
| aging | strength | | | | | | |
| (135° C. × | change (%) | | | | | | |
| 168 hrs) | elongation | −15 | −25 | 15 | 10 | 9 | ±40 or less |
| | change (%) | | | | | | |
| | amount of | 0.02 | 0.04 | 0.04 | 0.06 | 0.02 | 0.5 or less |
| | hydrogen | | | | | | |
| | chloride gas | | | | | | |
| | generated | | | | | | |
| | (%) | | | | | | |
| cross- | HOT/SET(%) | 125/5 | 75/-10 | 75/-5 | 160/10 | 150/10 | 175/15 or |
| linking | | | | | | | less |
| character- | | | | | | | |
| istics | | | | | | | |
| flame | Cable | NG | NG | PASS | NG | PASS | natural |
| retardancy | Vertical | | | | | | extinguishing |
| | Ignition | | | | | | |
| | scratch | 142 | 138 | 125 | 132 | 110 | 100 or more |
| | resistance | | | | | | |
| | (count of | | | | | | |
| | round trips) | | | | | | |
| cable | speed of | 150 | 150 | 150 | 150 | 150 | 150 or more |
| workability | cable | or | or | or | or | or | |
| | working | more | more | more | more | more | |
| | (M/min) | | | | | | |

| | | | | | |
|---|---|---|---|---|---|
| Appropriate | appro- | appro- | appro- | appro- | appro- |
| /inappropriate | priate | priate | priate | priate | priate |

From the results of Table 4, when the content of the polyethylene ethyl acrylate resin was outside the range of 20% to 40% by weight of the base resin, the flame retardancy was not sufficient. Therefore, the specimen was completely burned out during the cable vertical test. When the content of the graft resin was reduced, the tensile strength and elongation rate were significantly lowered.

Therefore, it can be seen that the content of the graft resin is preferably in the range of 30% to 40% by weight of the total base resin.

In addition, it can be seen that when the polyolefin elastomer is not used, the high-temperature insulation resistance value is remarkably lowered.

### Examples 5 to 6

An extrudate was prepared in the same manner as in Example 1, except that the compositions shown in Table 5 were used. Specific used examples of raw materials are the same as those used in the above examples.

TABLE 5

| processing | | | | | |
|---|---|---|---|---|---|
| sequence | | name of | | | |
| and | | raw | example | | |
| equipment | raw material | material | 1 | 5 | 6 |
| primary | base resin | EEA | 30 | 30 | 30 |
| compound | (100 parts | POE | 30 | 30 | 30 |
| (kneading) | by weight) | Graft | 40 | 40 | 40 |
| | | Resin | | | |
| | flame | Si-MDH | 130 | 140 | 120 |
| | retardant | | | | |
| | (part by | | | | |
| | weight) | | | | |
| | other | PE wax | 4 | 4 | 4 |
| | additives | antioxidant | 3 | 3 | 3 |
| | (part by | | | | |
| | weight) | | | | |
| secondary | primary compound | | 100 | 100 | 100 |
| compound | cross- | VTMOS | 1.5 | 1.5 | 1.5 |
| processing | linking | DCP | 0.12 | 0.12 | 0.12 |
| with | agent | | | | |
| uniaxial | (part by | | | | |
| extruder | weight) | | | | |

The extrudate obtained as described above was evaluated by the evaluation method described in Examples 1 to 4, and the results are shown in Table 6 below.

TABLE 6

| | measurement | Example | | | required |
|---|---|---|---|---|---|
| | item | 1 | 5 | 6 | performance |
| room | tensile | 13 | 127 | 14.2 | 9 or more |
| temperature | strength | | | | |
| | (N/mm²) | | | | |
| | Elongation | 250 | 242 | 280 | 125 or |
| | (%) | | | | more |
| high | insulation | 100 | 95 | 106 | 3.67 or |
| temperature | resistance | | | | more |
| (90° C.) | (MΩ*km) | | | | |
| thermal | tensile | 20 | 21 | 16 | ±40 or |
| aging | strength | | | | less |
| (135° C. × | change (%) | | | | |
| 168 hrs) | elongation | −15 | −18 | −15 | ±40 or |
| | change (%) | | | | less |
| | amount of | 0.03 | 0.02 | 0.03 | 0.5 or |
| | hydrogen | | | | less |
| | chloride gas | | | | |
| | generated (%) | | | | |
| cross- | HOT/SET (%) | 100/5 | 100/5 | 100/0 | 175/15 or |
| linking | | | | | less |
| character- | | | | | |
| istics | | | | | |
| flame | Cable | Pass | Pass | Pass | natural |
| retardancy | Vertical | | | | extinguish- |
| | Ignition | | | | ing |
| | scratch | 152 | 168 | 150 | 100 or |
| | resistance | | | | more |
| | (count of | | | | |
| | round trips) | | | | |
| cable | speed of | 150 or | 150 or | 150 or | 150 or |
| workability | cable | more | more | more | more |
| | working | | | | |
| | (M/min) | | | | |

| | | | |
|---|---|---|---|
| Appropriate/ | appro- | appro- | appro- |
| inappropriate | priate | priate | priate |

From the results of Table 6, it can be confirmed that the scratch resistance is improved as the content of magnesium hydroxide surface-treated with a silane coupling agent increases.

### Comparative Examples 6 to 11

An extrudate was prepared in the same manner as in Example 1, except that the compositions shown in Table 7 were used. Specific use examples of the remaining raw materials except for several materials of retardants are the same as those used in the above examples.

TABLE 7

| processing | | | | | | | | |
|---|---|---|---|---|---|---|---|---|
| sequence | | name of | | | | | | |
| and | raw | raw | comparative example | | | | | |
| equipment | material | material | 6 | 7 | 8 | 9 | 10 | 11 |
| primary | base resin | EEA | 30 | 30 | 30 | 30 | 30 | 30 |
| compound | (100 parts | POE | 30 | 30 | 30 | 30 | 30 | 30 |
| (kneading) | by weight) | Graft | 40 | 40 | 40 | 40 | 40 | 40 |
| | | Resin | | | | | | |
| | flame | Si-MDH | 150 | 110 | 65 | 65 | — | — |
| | retardant | MDH | — | — | 65 | — | — | 130 |
| | (part by | ATH | — | — | — | 65 | 130 | — |
| | weight) | | | | | | | |
| | other | PE wax | 4 | 4 | 4 | 4 | 4 | 4 |
| | additives | antioxi- | 3 | 3 | 3 | 3 | 3 | 3 |
| | (part by | dant | | | | | | |
| | weight) | | | | | | | |
| secondary | primary compound | | 100 | 100 | 100 | 100 | 100 | 100 |
| compound | cross- | VTMOS | 1.5 | 1.5 | 1.5 | 1.5 | 1.5 | 1.5 |
| processing | linking | DCP | 0.12 | 0.12 | 0.12 | 0.12 | 0.12 | 0.12 |
| with | agent | | | | | | | |
| uniaxial | (part by | | | | | | | |
| extruder | weight) | | | | | | | |

MDH Co., Ltd.: magnesium hydroxide flame retardant, the average particle size of 3 μm to 4μ, Shandong company, YB-LA
ATH: aluminum hydroxide, the average particle size of 1.2 μm to 1.5 μm, KC, KH-101LC

The extrudate obtained as described above was evaluated by the evaluation method described in Examples 1 to 4, and the results are shown in Table 8 below.

TABLE 8

| | measurement | comparative example | | | | | | Requireed |
|---|---|---|---|---|---|---|---|---|
| | item | 6 | 7 | 8 | 9 | 10 | 11 | performance |
| room | tensile | 138 | 8.8 | 10.1 | 39 | 111 | 12.9 | 9 or |
| temper- | strength | | | | | | | more |
| ature | (N/mm²) | | | | | | | |
| | Elongation | 200 | 325 | 217 | 231 | 150 | 242 | 125 or |
| | (%) | | | | | | | more |
| high | insulation | 103 | 110 | 101 | 95 | 80 | 98 | 3.67 or |
| temper- | resistance | | | | | | | more |
| ature | (MΩ*km) | | | | | | | |
| (90° C.) | | | | | | | | |
| thermal | tensile | 23 | 18 | 20 | 22 | 19 | 16 | ±40 or |
| aging | strength | | | | | | | less |
| (135° C. × | change (%) | | | | | | | |
| 168 hrs) | elongation | −16 | −14 | −12 | 5 | 10 | −15 | ±40 or |
| | change (%) | | | | | | | less |
| | amount of | 0.03 | 0.04 | 0.02 | 0.05 | 0.04 | 0.02 | 0.5 or |
| | hydrogen | | | | | | | less |
| | chloride | | | | | | | |
| | gas | | | | | | | |
| | generated | | | | | | | |
| | (%) | | | | | | | |
| cross- | HOT/SET | 85/0 | 100/0 | 95/0 | 120/10 | 150/−10 | 110/0 | 175/15 |
| linking | (%) | | | | | | | or less |
| character- | | | | | | | | |
| istics | | | | | | | | |
| flame | Cable | PASS | NG | PASS | NG | NG | PASS | natural |
| retard- | Vertical | | | | | | | extinguish- |
| ancy | Ignition | | | | | | | ing |
| | scratch | 167 | 153 | 80 | 168 | 162 | 65 | 100 or |
| | resistance | | | | | | | more |
| | (count of | | | | | | | |
| | round | | | | | | | |
| | trips) | | | | | | | |
| cable | speed of | 100 | 150 | 150 | 60 | 30 or | 150 | 150 or |
| workab- | cable | | | | | less | | more |
| ility | working | | | | | | | |
| | (M/min) | | | | | | | |

| Appropriate | inappropriate |
|---|---|
| /inappropriate | |

From the results of Table 8, it can be seen that when aluminum hydroxide is used as a flame retardant, the scratch resistance is good, but the extrusion speed and elongation are lowered. To improve the extrusion speed during extrusion, improve the surface scratch resistance, and satisfy a stable elongation rate, it is preferable to use magnesium hydroxide that is surface-treated with a silane coupling agent as a flame retardant, and the content of the flame retardant is preferably 120 to 140 parts by weight per 100 parts by weight of the base resin.

### Examples 7 to 11

An extrudate was prepared in the same manner as in Example 1, except that the compositions shown in Table 9 were used. Specific used examples of raw materials are the same as those used in the above examples.

TABLE 9

| processing | | | | | | | | |
|---|---|---|---|---|---|---|---|---|
| sequence | | name of | | | | | | |
| and | raw | raw | example | | | | | |
| equipment | material | material | 1 | 7 | 8 | 9 | 10 | 11 |
| primary | base resin | EEA | 30 | 30 | 30 | 30 | 30 | 30 |
| compound | (100 parts | POE | 30 | 30 | 30 | 30 | 30 | 30 |
| (kneading) | by weight) | Graft | 40 | 40 | 40 | 40 | 40 | 40 |
| | Resin | | | | | | | |
| | flame | Si-MDH | 130 | 130 | 130 | 130 | 130 | 130 |
| | retardant | | | | | | | |
| | (part by | | | | | | | |
| | weight) | | | | | | | |
| | other | PE wax | 4 | 4 | 4 | 4 | 4 | 4 |
| | additives | antioxi- | 3 | 3 | 3 | 3 | 3 | 3 |
| | (part by | dant | | | | | | |
| | weight) | | | | | | | |
| secondary | primary compound | | 100 | 100 | 100 | 100 | 100 | 100 |
| compound | cross- | VTMOS | 1.5 | 1.5 | 1.5 | 1.5 | 1.5 | 1.5 |
| processing | linking | DCP | 0.12 | 0.12 | 0.12 | 0.12 | 0.12 | 0.12 |
| with | agent | | | | | | | |
| uniaxial | (part by | | | | | | | |
| extruder | weight) | | | | | | | |

The above examples are presented to understand the effect of the cross-linking agent on cross-linking properties and extrudability. For this, only cross-linking properties and extruded appearance were evaluated.

In the test, the fracture of the extruded appearance was determined by whether or not a protrusion with a size of 0.1 mm or more occurred after an electric wire was cut into a length of 1 m. When there is no tearing or foaming, it is evaluated as good.

The measurement results are shown in Table 10 below.

TABLE 10

| | Measurement | example | | | | | | required |
|---|---|---|---|---|---|---|---|---|
| | item | 1 | 7 | 8 | 9 | 10 | 11 | performance |
| cross- | Hot/Set | 100/5 | 95/0 | 100/5 | 125/15 | 150/20 | 175/10 | 175/75 |
| linking | (%) | | | | | | | or less |
| character- | | | | | | | | |
| istics | | | | | | | | |
| wire | extrusion | good | good | good | good | good | good | |
| extruder | appearance | | | | | | | |

### Reference Examples 1 to 4

An extrudate was prepared in the same manner as in Example 1, except that the compositions shown in Table 11 were used. Specific used examples of raw materials are the same as those used in the above examples.

TABLE 11

| processing | | | | | | |
|---|---|---|---|---|---|---|
| sequence | | name of | | | | |
| and | | raw | reference example | | | |
| equipment | raw material | material | 1 | 2 | 3 | 4 |
| primary | base resin | EEA | 30 | 30 | 30 | 30 |
| compound | (100 parts by | POE | 30 | 30 | 30 | 30 |
| (kneading) | weight) | Graft | 40 | 40 | 40 | 40 |
| | | Resin | | | | |
| | flame retardant | Si-MDH | 130 | 130 | 130 | 130 |
| | (part by weight) | | | | | |
| | other additives | PE wax | 4 | 4 | 4 | 4 |
| | (part by weight) | Antioxidant | 3 | 3 | 3 | 3 |
| secondary | primary compound | | 100 | 100 | 100 | 100 |
| compound | cross-linking | VTMOS | 1.5 | 1.5 | 1.5 | 1.5 |
| processing | agent | DCP | 0.3 | 0.2 | 0.15 | 0.08 |
| with | (part by weight) | | | | | |
| uniaxial | | | | | | |
| extruder | | | | | | |

The above examples are presented to understand the effect of the cross-linking agent on cross-linking properties and extrudability. For this, only cross-linking properties and extruded appearance were evaluated.

The results are shown in Table 12 below.

TABLE 12

| | Measure- | reference example | | | | required |
|---|---|---|---|---|---|---|
| | ment item | 1 | 2 | 3 | 4 | performance |
| cross- | Hot/Set | 25/0 | 50/0 | 75/0 | 175/20 | 175/75 or |
| linking | (%) | | | | | less |
| character- | | | | | | |
| istics | | | | | | |
| wire | extrusion | good | good | good | good | |
| extruder | appearance | | | | | |

In the case of Reference Example 1, cross-linking proceeds rapidly in an extruder, which may result in the occurrence of scorching and may have some disadvantages in terms of extrusion performance and appearance stability. In the case of Reference Examples 2 and 3, when a cable extrusion process is performed at high speed, there is a risk of scorching. Therefore, a high-speed extrusion furnace has some disadvantages.

In the case of Reference Example 4, since the cross-linking property was somewhat unstable, it was necessary to control the combination of screws and the retention time in the extruder.

### Comparative Example 12

An extrudate was prepared in the same manner as in Example 1, except that the compositions shown in Table 13 were used. Specific used examples of raw materials are the same as those used in the above examples.

TABLE 13

| processing | | | | |
|---|---|---|---|---|
| sequence | | name of | | Comparative |
| and | | raw | | example |
| equipment | raw material | material | Example 1 | 12 |
| primary | base resin | EEA | 30 | — |
| compound | (100 parts by | EVA | — | 30 |
| (kneading) | weight) | POE | 30 | 30 |
| | | Graft | 40 | 40 |
| | | Resin | | |
| | flame retardant | Si-MDH | 130 | 130 |
| | (part by weight) | | | |
| | other additives | PE wax | 4 | 4 |
| | (part by weight) | Antiox- | 3 | 3 |
| | | idant | | |
| secondary | primary compound | | 100 | 100 |
| compound | cross-linking | VTMOS | 1.5 | 1.5 |
| processing | agent | DCP | 0.12 | 0.12 |
| with | (part by weight) | | | |

uniaxial
extruder

The comparative examples are presented to determine the effect of polyethylene ethyl acrylate as a base resin on smoke generation in case of fire. For this, only a smoke density evaluation was performed, and the results are shown in Table 14 below.

The evaluation of smoke density was tested according to an ASTM E662 (flame mode) test method.

TABLE 14

| | | comparative | performance |
|---|---|---|---|
| | Example 1 | example 12 | reference |
| smoke | 72 | 138 | 100 or less |
| density (Ds) | | | |

low-toxicity flame-retardant polyolefin insulated cables are used mainly for indoor wiring in buildings. In the event of a fire, smoke may be generated from these cables and block the view of people inside the building.

When polyethylene ethyl acrylate is included in the base resin, the smoke density is significantly lowered compared to the case of using ethylene vinyl acetate. Therefore, it is expected that the insulated cable of the present disclosure significantly reduces the amount of smoke generated in case of fire.

1. A low-toxicity flame-retardant polyolefin-based insulating resin composition comprising:
100 parts by weight of a base resin comprising 20% to 40% by weight of polyethylene ethyl acrylate, 20% to 40% by weight of polyolefin elastomer, and 30% to 40% by weight of a linear low-density polyethylene resin grafted with maleic anhydride; and
120 to 140 parts by weight of magnesium hydroxide that is surface treated with a silane coupling agent, the magnesium hydroxide serving as a flame retardant.

2. The composition of claim 1, comprising:
a primary compound composition comprising 100 parts by weight of the base resin and 120 to 140 parts by weight of the flame retardant, the base rein comprising 20% to 40% by weight of polyethylene ethyl acrylate, 20% to 40% by weight of polyolefin elastomer, and 30% to 40% by weight of a linear low-density polyethylene resin grafted with maleic anhydride, the flame retardant comprising magnesium hydroxide that is surface-treated with a silane coupling agent; and
a cross-linking agent.

3. The composition of claim 1,
wherein the polyolefin elastomer comprises an ethylene-octane-based copolymer, an ethylene-butene-based copolymer, or a mixture thereof.

4. The composition of claim 2,
wherein the cross-linking agent comprises a mixture of vinyltrimethoxysilane (VTMOS) and dicumyl peroxide.

5. The composition of claim 2,
wherein the cross-linking agent comprises a mixture of 1 to 2 parts by weight of vinyltrimethoxysilane (VTMOS) and 0.1 to 0.12 parts by weight of dicumyl peroxide per 100 parts by weight of the primary compound composition.

6. A low-toxicity flame-retardant polyolefin-based insulated electric cable comprising a cross-linked product of a primary compound composition comprising:
100 parts by weight of a base resin comprising 20% to 40% by weight of polyethylene ethyl acrylate, 20% to 40% by weight of polyolefin elastomer, and 30% to 40% by weight of a linear low-density polyethylene resin grafted with maleic anhydride; and
120 to 140 parts by weight of magnesium hydroxide that is surface-treated with a silane coupling agent, serving as a flame retardant.

7. The insulated electric cable of claim 6,
wherein the polyolefin elastomer comprises an ethylene-octane-based copolymer, an ethylene-butene-based copolymer, or a mixture thereof.

8. The insulated electric cable of claim 6,
wherein the cross-linked product is obtained by using a mixture of vinyltrimethoxysilane (VTMOS) and dicumyl peroxide.

9. The insulated electric cable of claim 6,
wherein the cross-linked product is obtained by using a mixture of 1 to 2 parts by weight of vinyltrimethoxysilane (VTMOS) and 0.1 to 0.12 parts by weight of dicumyl peroxide per 100 parts by weight of the primary compound composition.

10. A method of manufacturing a low-toxicity flame-retardant polyolefin-based insulated cable, the method comprising:
preparing a primary compound composition comprising 100 parts by weight of a base resin and 120 to 140 parts by weight of a flame retardant, the base rein comprising 20% to 40% by weight of polyethylene ethyl acrylate, 20% to 40% by weight of polyolefin elastomer, and 30% to 40% by weight of a linear low-density polyethylene resin grafted with maleic anhydride, the flame retardant comprising magnesium hydroxide that is surface-treated with a silane coupling agent; and
preparing a cross-linked product by performing reactive extrusion with the primary compound.

11. The method of claim 10,
wherein the polyolefin elastomer comprises an ethylene-octane-based copolymer, an ethylene-butene-based copolymer, or a mixture thereof.

12. The method of claim 10,
wherein the reactive extrusion is performed by using a mixture of vinyltrimethoxysilane (VTMOS) and dicumyl peroxide as a cross-linking agent.

13. The method of claim 10,
wherein the reactive extrusion is performed by using a mixture of 1 to 2 parts by weight of vinyltrimethoxysilane (VTMOS) and 0.1 to 0.12 parts by weight of dicumyl peroxide per 100 parts by weight of the primary compound composition, as the cross-linking agent.
